(19) United States
(12) Patent Application Publication
(10) Pub. No.: US 2026/0314633 A1
(43) Pub. Date: Oct. 15, 2026

(54) TREATED SOY PROTEIN PRODUCT AND METHOD OF MAKING THE SAME

(71) Applicant: Cargill, Incorporated, Wayzata, MN (US)

(72) Inventors: Yara Licceth Benavides Paz, Plymouth, MN (US); Alexandra Jean Fiegel, Albertville, MN (US); Chathurada Sugeeshvarie Gajadeera, Plymouth, MN (US); Daniel Scott Gaspard, Victoria, MN (US); Mohammad Sharif Khan, Rogers, MN (US); Erika Lyn McConville, Golden Valley, MN (US); Michael Alan Mortenson, Rogers, MN (US); Michael Arthur Porter, Maple Grove, MN (US)

(73) Assignee: Cargill, Incorporated, Wayzata, MN (US)

(21) Appl. No.: 19/481,231

(22) PCT Filed: May 6, 2024
(86) PCT No.: PCT/US2024/028026

§ 371 Date: Nov. 4, 2025

Related U.S. Application Data
(60) Provisional application No. 63/500,875, filed on May 8, 2023.

(51) Int. Cl. A23J 3/16; A23J 3/26

(52) U.S. Cl. CPC A23J 3/16; A23J 3/26

(57) ABSTRACT

The disclosure relates to a treated soy protein product and a method of making the same. The method comprises providing an extruded soy protein material and performing a washing step on the extruded soy protein material to generate the treated soy protein product. The treated soy protein product has one or more improved attributes compared to the extruded soy protein material. Further, the disclosure relates to a method of washing an extruded soy protein material to obtain a treated soy protein product.

### CROSS-REFERENCE TO RELATED APPLICATIONS

This application claims the benefit of U.S. Provisional Patent Application No. 63/500,875, filed May 8, 2023, which is hereby incorporated by reference in its entirety.

### BACKGROUND

Extruded vegetable protein products have long been used for extending processed meat products and as bases for meat analogs. A conventional way to make extruded vegetable protein products, such as extruded textured soy concentrate, involves purifying the soy protein using extraction with aqueous ethanol followed by solvent evaporation. The products can then be extruded into forms useful in extending meat products.

In meat analogs, the issue of protein concentration is important and there is a demand to have meat analogs with higher protein concentration. Thus, an extruded vegetable protein product (e.g., a treated soy protein concentrate product) having improved traits (e.g., a higher protein content) and an improved method for making such product is needed.

### SUMMARY

The present disclosure provides a method of making a treated soy protein product comprising the steps of providing an extruded soy protein material; and performing a washing step on the extruded soy protein material to obtain the treated soy protein product. The washing step comprises washing the extruded soy protein material at a washing temperature of from room temperature to 85° C. with a washing agent in a ratio of, washing agent to extruded soy protein material, from 4:1 to 40:1. The treated soy protein product has one or more improved attributes compared to the extruded soy protein material.

The present disclosure also provides a method of washing an extruded soy protein material comprising the steps of washing the extruded soy protein material at a washing temperature of from room temperature to 85° C. with a washing agent in a ratio of, washing agent to extruded soy protein material, from 4:1 to 40:1 to obtain a washed material; and drying the washed material at a drying temperature of 75° C. to 120° C. to obtain a treated soy protein product. The treated soy protein product has one or more improved attributes compared to the extruded soy protein material.

Also described herein is a treated soy protein product produced by any of the above methods.

The present disclosure further provides a treated soy protein product having one or more improved attributes compared to an unwashed extruded soy protein material. The one or more improved attributes are selected from the group consisting of an increased protein content, a reduced flavor component content, a reduced metal ion content, a reduced odor content, a reduced carbohydrate content, a reduced free amino acid content, and any combinations thereof.

### BRIEF DESCRIPTION OF THE FIGURES

The drawings illustrate generally, by way of example, but not by way of limitation, various aspects discussed in the present document.

FIG. 1 shows changes in concentrations of compounds in the washed and unwashed samples.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are based on a dry weight basis. Percentage based on a dry weight basis is also referred to as wt % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

As used herein, the term “extruded” refers to a description for a material that has undergone an extrusion process. For example, an “extruded material” refers to a material that has passed through an extruder (using single or twin-screw configurations), together with sufficient water to create an “extruded product”. Historically, some extruded protein ingredients have been called textured vegetable protein (e.g., textured soy protein), or various other names indicating a protein type after extrusion.

During the most common type of protein extrusion, a hydrated protein ingredient is heated while shearing such that an extruded mass reaches above the boiling point of water. The extruded mass passes through an orifice such that there is a sudden change in pressure and the water boils creating steam. The steam expands the structure resulting in an extruded structure. Regulation of the pressure drop, temperature, moisture, and feed rate allow one skilled in the art to create different sizes, shapes, and textures of extruded products. The extruded product can be dried in a variety of conventional dryers or used without drying in the invention described here.

As used herein, “room temperature” or “RT” refers to a temperature between 20° C. to 25° C.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

Described herein is a treated soy protein product and a method of making the treated soy protein product. The treated soy protein product has at least 75 weight percent (wt %) protein on a dry basis. The treated soy protein product is suitable for use as a protein source for incorporation into foods for human and/or animal consumption.

### Method of Making Treated Soy Protein Product

A method of making a treated soy protein product described in the present disclosure comprises the steps of: (a) providing an extruded soy protein material, and (b) performing a washing step on the extruded soy protein material to obtain the treated soy protein product. The washing step comprises washing the extruded soy protein material at a washing temperature of from room temperature to 85° C. with a washing agent in a ratio of, washing agent to extruded soy protein material, from 4:1 to 40:1. The resulting treated soy protein product has one or more improved attributes compared to the extruded soy protein material.

Preferably, the one or more improved attributes may include, but may not be limited to, an increased protein content, a reduced flavor component content, a reduced metal ion content, a reduced odor content, a reduced carbohydrate content, a reduced free amino acid content, or any combinations thereof.

Extruded soy protein material serves as the starting material being fed to the washing step.

Preferably, the extruded soy protein material is extruded soy protein concentrate (TSC).

Examples of extruded soy protein material may include soy protein derived from sources such as soy protein isolate and soy protein concentrate that has undergone an extrusion process (i.e., extruded soy protein).

The extruded soy protein material can have a protein content (initial protein content) of at least 70 wt %, 72 wt %, 75 wt %, 78 wt %, 80 wt %, 82 wt %, or 85 wt % on a dry basis. For example, the extruded soy protein material can have a protein content can be in a range of from 70 to 85 wt %, from 72 to 82 wt %, or from 75 to 80 wt % on a dry basis.

In one aspect, the protein content of the treated soy protein product can be at least 75 wt %, 78 wt %, 80 wt %, 82 wt %, 85 wt %, 88 wt %, or 90 wt % on a dry basis. For example, the protein content of the treated soy protein product can be in a range of from 75 to 90 wt %, from 78 to 88 wt %, or from 80 to 85 wt % on a dry basis.

In one aspect, the washing temperature can be room temperature, 45° C., 50° C., 55° C., 60° C., 65° C., 70° C., 75° C., 80° C., or 85° C. For example, the washing temperature can be in a range of from room temperature to 85° C., from room temperature to 80° C., from room temperature to 75° C., from room temperature to 70° C., from room temperature to 65° C., from room temperature to 60° C., from room temperature to 55° C., from room temperature to 50° C., from room temperature to 45° C., from 45 to 85° C., from 45 to 80° C., from 45 to 75° C., from 45 to 70° C., from 45 to 60° C., from 50 to 85° C., from 50 to 80° C., from 50 to 75° C., from 50 to 70° C., from 50 to 65° C., from 55 to 85° C., from 55 to 80° C., from 55 to 75° C., from 55 to 70° C., from 60 to 85° C., from 60 to 80° C., from 60 to 75° C., from 65 to 85° C., from 65 to 80° C., or from 65 to 75° C.

Preferably, the washing temperature can be in a range of from room temperature to 85° C., more preferably of from 65 to 75° C.

In one aspect, a washing agent can be water (e.g., tap water or deionized water) or water with acid added.

In an aspect, the pH of the washing agent can be 4, 4.15, 4.55, 4.85, 5, 5.15, 5.45 or 5.75. For example, the pH of the washing agent can be in a range of from 4 to 5.75, from 4 to 5.45, from 4 to 5.15, from 4 to 4.85, from 4 to 4.55, from 4.15 to 5.75, from 4.15 to 5.45, from 4.15 to 5.15, from 4.15 to 4.85, from 4.25 to 5.75, from 4.25 to 5.45, from 4.25 to 5.15, from 4.25 to 4.85, from 4.25 to 4.55, from 4.55 to 5.75, from 4.55 to 5.45, from 4.55 to 5.15, from 4.55 to 4.85, from 4.75 to 5.25, from 4.85 to 5.75, from 4.85 to 5.45, from 4.85 to 5.15, from 5.15 to 5.75, from 5.15 to 5.45, or from 5.45 to 5.75.

In one aspect, duration of the washing step can be 10 minutes, 15 minutes, 20 minutes, 25 minutes, or 30 minutes. For example, the duration can be in a range of from 10 to 30 minutes, from 10 to 25 minutes, from 10 to 20 minutes, from 15 to 30 minutes, or from 15 to 25 minutes.

In one aspect, the washing step is a co-current washing or countercurrent washing. When a countercurrent washing scheme is used, a smaller total volume of washing agent would be used but the duration of the entire washing period would be the same.

In an aspect, the washing step can be performed for one time, at least one time, two times, at least twice, three times, or at least thrice. Preferably, one or more process parameters of the method can be the same or different in each washing step, where the process parameters may include, but may not be limited to, a ratio of the washing agent to the extruded soy protein material, pH of the washing agent, washing temperature, or duration of washing.

For example, a washing agent for a first washing step (initial washing agent) can be water with acid added. The pH of the initial washing agent can be 4 to 5.75, preferably 4.25 to 5.25.

Washing agent(s) for subsequent washing step(s) (subsequent washing agent(s)) can be water having the same or, preferably, different pH from the pH of the initial washing agent.

In one aspect, a ratio of washing agent to extruded soy protein material in the washing step can be in a ratio of from 4:1 to 40:1, from 4:1 to 35:1, from 4:1 to 30:1, from 4:1 to 25:1, from 4:1 to 20:1, from 4:1 to 15:1, from 4:1 to 10:1, from 4:1 to 7:1, from 4:1 to 6:1, 4:1 to 5:1, from 5:1 to 10:1, from 5:1 to 9:1, from 5:1 to 8:1, from 5:1 to 7:1, rom 6:1 to 10:1, from 6:1 to 8:1, or from 6:1 to 5:1. In an aspect, the washing agent to the extruded soy protein material in the washing step can be in a ratio of 5:1, 6:1, or 10:1. For example, the extruded soy protein material can be washed using countercurrent extraction at a ratio of 5:1, 6:1, or 10:1.

Preferably, the washing step can be performed three times and the ratio of the washing agent to the extruded soy protein material in each washing step can be from 4:1 to 10:1, preferably from 5:1 to 10:1.

Preferably, the ratio of the washing agent to the extruded soy protein material is a weight ratio.

In one aspect, the method also includes a step of drying the treated soy protein product at a drying temperature of 75° C., 80° C., 85° C., 90° C., 95° C., 100° C., 105° C., 110° C., 115° C., or 120° C. For example, the treated soy protein product can be dried at a drying temperature in a range of from 75 to 120° C., from 80 to 115° C., from 85 to 110° C., from 90 to 105° C., or from 95 to 100° C. A skilled artesian would appreciate that the treated soy protein product can be dried under different drying methods with different drying parameters.

### Method of Washing Extruded Soy Protein Material

In one aspect, this disclosure also describes a method of washing an extruded soy protein material. The method comprises steps of: (a) washing the extruded soy protein material at a washing temperature of from room temperature to 85° C. with a washing agent in a ratio of, washing agent to extruded soy protein material, from 4:1 to 40:1 to obtain a washed material, and (b) drying the washed material at a drying temperature of from 75° C. to 120° C. to obtain a treated soy protein product. The resulting treated soy protein product (i.e., washed extrude soy protein material) has one or more improved attributes compared to the extruded soy protein material (i.e., unwashed starting material).

Preferably, the treated soy protein product has a protein content of at least 75 wt % on a dry basis.

In one aspect, one or more process parameters of the method can be the same or different in each washing step. Preferably, the one or more process parameters may include, but may not be limited to, a ratio of the washing agent to the extruded soy protein material, pH of the washing agent, washing temperature, or duration of washing.

Preferably, the present invention provides a method of increasing protein content in a treated soy protein product by washing an extruded soy protein material, wherein the treated soy protein product (i.e., washed extruded soy protein material) has an increased protein content compared to the extruded soy protein material (i.e., unwashed starting material); more preferably, the washing process is described in this disclosure, such as in paragraphs [0018] to [0038].

Preferably, the present invention provides a method of reducing flavor component content in a treated soy protein product by washing an extruded soy protein material, wherein the treated soy protein product (i.e., washed extruded soy protein material) has a reduced flavor content compared to the extruded soy protein material (i.e., unwashed starting material); more preferably, the washing process is described in this disclosure, such as in paragraphs [0018] to [0038].

Preferably, the present invention provides a method of reducing metal ion content in a treated soy protein product by washing an extruded soy protein material, wherein the treated soy protein product (i.e., washed extruded soy protein material) has a reduced metal ion content compared to the extruded soy protein material (i.e., unwashed starting material); more preferably, the washing process is described in this disclosure, such as in paragraphs [0018] to [0038].

Preferably, the present invention provides a method of reducing odor content in a treated soy protein product by washing an extruded soy protein material, wherein the treated soy protein product (i.e., washed extruded soy protein material) has a reduced odor content compared to the extruded soy protein material (i.e., unwashed starting material); more preferably, the washing process is described in this disclosure, such as in paragraphs [0018] to [0038].

Preferably, the present invention provides a method of reducing carbohydrate content in a treated soy protein product by washing an extruded soy protein material, wherein the treated soy protein product (i.e., washed extrude soy protein material) has a reduced carbohydrate content compared to the extruded soy protein material (i.e., unwashed starting material); more preferably, the washing process is described in this disclosure, such as in paragraphs [0018] to [0038].

Preferably, the present invention provides a method of reducing free amino acid content in a treated soy protein product by washing an extruded soy protein material, wherein the treated soy protein product (i.e., washed extrude soy protein material) has a reduced free amino acid content compared to the extruded soy protein material (i.e., unwashed starting material); more preferably, the washing process is described in this disclosure, such as in paragraphs [0018] to [0038].

### Treated Soy Protein Product

Preferably, the treated soy protein product of the present invention, made by any method described in this disclosure, has one or more improved attributes as compared to an unwashed extruded soy protein material. Examples of an unwashed extruded soy protein material may include, but may not be limited to, an extruded soy protein starting material of the present invention that has not been subjected to the washing process of the present invention as described in this disclosure, and/or an equivalent extruded soy protein product made by methods other than the method of the present invention.

The term “equivalent extruded soy protein product” as used herein refers to a soy protein product produced from the same starting material (e.g., from extruded soy protein of the same batch) which has been treated in the same way (e.g., same extrusion process, if any) except that it has not been subjected to the washing process of the present invention as described in this disclosure.

In one aspect, the one or more attributes that are improved as compared to an unwashed extruded soy protein material may include, but may not be limited to, an increased protein content, a reduced flavor component content, a reduced metal ion content, a reduced odor content, a reduced carbohydrate content, and a reduced free amino acid content.

Preferably, the treated soy protein product of the present invention may have an increased protein content, a reduced flavor component content, a reduced metal ion content, a reduced odor content, a reduced carbohydrate content, and a reduced free amino acid content as compared to an unwashed extruded soy protein material.

Preferably, the treated soy protein product described in this disclosure has an increased protein content as compared to an unwashed extruded soy protein material. In one aspect, the treated soy protein product of the present invention may have a protein content of at least 75 wt %, preferably at least 78 wt %, more preferably at least 80 wt %, on a dry basis.

Preferably, the treated soy protein product described in this disclosure has a reduced flavor component content as compared to an unwashed extruded soy protein material. In other words, the content of one or more flavor components in the treated soy protein product described in this disclosure is lower compared to an unwashed extruded soy protein material. Flavor components are substances present in treated soy protein product that impart a flavor (e.g., an earthy flavor, a savory flavor, a meaty flavor, a brothy flavor, a grainy flavor, a cereal flavor, a malty flavor, a toasted flavor, a beany flavor, a green flavor) to the treated soy protein product. Examples of the flavor components may include, but may not be limited to, furan, pyran, organic acid, aldehyde, alcohol, ketone, pyrazine, lactone, thiol, sulfide, or any combinations thereof.

In one aspect, the treated soy protein product described in this disclosure may have a lower aldehyde content, preferably a lower hexanal, heptanal, benzaldehyde, octanal, 2-methyl-pentanal, 4-ethyl-benzaldehyde, 2,4-nonadienal, 2,4-decandienal, and/or tolualdehyde content, compared to an unwashed extruded soy protein material. Aldehydes detectable by humans upon tasting may be so potent that they cannot be identified or quantified by conventional analytical chemistry and yet be decreased by the washing treatment of this invention.

Preferably, the treated soy protein product described in this disclosure may have aldehyde content that is at least 25%, preferably at least 50%, more preferably at least 75%, even more preferably at least 99% lower than the aldehyde content of an unwashed extruded soy protein material. For example, the treated soy protein product may have a hexanal content that is at least 1%, preferably at least 12%, more preferably at least 25% lower than the hexanal content of an unwashed extruded soy protein material. The treated soy protein product may have a heptanal content that is at least 69%, preferably at least 72%, more preferably at least 75% lower than the heptanal content of an unwashed extruded soy protein material. The treated soy protein product may have a benzaldehyde content that is at least 80%, preferably at least 81%, more preferably at least 83% lower than the benzaldehyde content of an unwashed extruded soy protein material. The treated soy protein product may have an octanal content that is at least 97%, preferably at least 98%, more preferably at least 99% lower than the octanal content of an unwashed extruded soy protein material. The treated soy protein product may have a 4-ethyl-benzaldehyde content that is at least 59%, preferably at least 64%, more preferably at least 70% lower than the octanal content of an unwashed extruded soy protein material. The treated soy protein product may have a 2,4-decandienal content that is at least 21%, preferably at least 43%, more preferably at least 64% lower than the 2,4-decandienal content of an unwashed extruded soy protein material. The treated soy protein product may have a tolualdehyde content that at least 97%, preferably at least 98%, more preferably at least 99% lower than the tolualdehyde content of an unwashed extruded soy protein material.

In one aspect, the treated soy protein product described in this disclosure may have a lower ketone content, preferably a 2-heptanone, 2-octanone, 2-hexanone, and/or 2-nonanone content, compared to an unwashed extruded soy protein material. Ketones detectable by humans upon tasting may be so potent that they cannot be identified or quantified by conventional analytical chemistry and yet be decreased by the washing treatment of this invention.

Preferably, the treated soy protein product described in this disclosure may have ketone content that is at least 90%, preferably at least 92%, more preferably at least 95%, even more preferably at least 99% lower than the ketone content of an unwashed extruded soy protein material. For example, the treated soy protein product may have a 2-heptanone content that is at least 95%, preferably at least 96%, more preferably at least 97% lower than the 2-heptanone content of an unwashed extruded soy protein material. The treated soy protein product may have a 2-octanone content that is at least 93%, preferably at least 98%, more preferably at least 99% lower than the 2-octanone content of an unwashed extruded soy protein material. The treated soy protein product may have a 2-hexanone content that is at least 97%, preferably at least 98%, more preferably at least 99% lower than the 2-hexanone content of an unwashed extruded soy protein material. The treated soy protein product may have a 2-nonanone content that is at least 93%, preferably at least 94%, more preferably at least 95% lower than the 2-nonanone content of an unwashed extruded soy protein material.

In one aspect, the treated soy protein product described in this disclosure may have a lower furan content, preferably a lower 2-ethyl-furan, 2-pentyl-furan, 2-butyl-furan, and/or 2-propyl-furan content, compared to an unwashed extruded soy protein material. Furans detectable by humans upon tasting may be so potent that they cannot be identified or quantified by conventional analytical chemistry and yet be decreased by the washing treatment of this invention.

Preferably, the treated soy protein product described in this disclosure may have furan content that is at least 70%, preferably at least 85%, more preferably at least 95%, even more preferably at least 99% lower than the furan content of an unwashed extruded soy protein material. For example, the treated soy protein product may have a 2-ethyl-furan content that is at least 97%, preferably at least 98%, more preferably at least 99% lower than the 2-ethyl-furan content of an unwashed extruded soy protein material. The treated soy protein product may have a 2-pentyl-furan content that is at least 71%, preferably at least 74%, more preferably at least 78% lower than the 2-pentyl-furan content of an unwashed extruded soy protein material. The treated soy protein product may have a 2-butyl-furan content that is at least 87%, preferably at least 90%, more preferably at least 93% lower than the 2-butyl-furan content of an unwashed extruded soy protein material. The treated soy protein product may have a 2-propyl-furan content that is at least 97%, preferably at least 98%, more preferably at least 99% lower than the 2-propyl-furan content of an unwashed extruded soy protein material.

In one aspect, the treated soy protein product described in this disclosure may have a lower pyrazine content, preferably a lower 2-ethyl-6-methyl-pyrazine content, compared to an unwashed extruded soy protein material. Pyrazines detectable by humans upon tasting may be so potent that they cannot be identified or quantified by conventional analytical chemistry and yet be decreased by the washing treatment of this invention.

Preferably, the treated soy protein product described in this disclosure may have pyrazine content that is at least 35%, preferably at least 40%, more preferably at least 45%, even more preferably at least 47% lower than the pyrazine content of an unwashed extruded soy protein material. For example, the treated soy protein product may have a 2-ethyl-6-methyl-pyrazine content that is at least 45%, preferably at least 46%, more preferably at least 47% lower than the 2-ethyl-6-methyl-pyrazine content of an unwashed extruded soy protein material.

In one aspect, the treated soy protein product described in this disclosure may have a lower alcohol content, preferably a lower 1-octen-3-ol and/or 2-ethyl-1-hexanol content, compared to an unwashed soy protein product. Alcohols detectable by humans upon tasting may be so potent that they cannot be identified or quantified by conventional analytical chemistry and yet be decreased by the washing treatment of this invention.

Preferably, the treated soy protein product described in this disclosure may have alcohol content that is at least 40%, preferably at least 70%, more preferably at least 80%, even more preferably at least 90% lower than the alcohol content of an unwashed extruded soy protein material. For example, the treated soy protein product may have a 1-octen-3-ol content that is at least 86%, preferably at least 88%, more preferably at least 90% lower than the 1-octen-3-ol content of an unwashed extruded soy protein material. The treated soy protein product may have a 2-ethyl-1-hexanol content that is at least 40%, preferably at least 56%, more preferably at least 71% lower than the 2-ethyl-1-hexanol content of an unwashed extruded soy protein material.

Preferably, the treated soy protein product described in this disclosure may have one or more flavor components content at least 50%, preferably at least 75%, more preferably at least 90%, lower than the one or more flavor components content of an unwashed extruded soy protein material. The one or more flavor components may include, but may not be limited to, heptanal, 2-heptanone, 2-ethyl-furan, 2-pentyl-furan, benzaldehyde, 1-octen-3-ol, octanal, 2-octanone, 2-butyl-furan, 2-ethyl-1-hexanol, 2-hexanone, 2-nonanone, 2-propyl-furan, 4-ethyl-benzaldehyde, tolualdehyde, or any combinations thereof.

More preferably, the treated soy protein product described in this disclosure may have one or more flavor component content is at least 97%, preferably at least 98%, more preferably at least 99%, lower than the one or more flavor components content of an unwashed extruded soy protein material. The one or more flavor components may include, but may not be limited to, 2-ethyl-furan, octanal, 2-propyl-furan, tolualdehyde, or any combinations thereof.

Preferably, the flavor components may include, but may not be limited to, hexanal, heptanal, benzaldehyde, octanal, 2-methyl-pentanal, 4-ethyl-benzaldehyde, 2,4-nonadienal, 2,4-decandienal, tolualdehyde, 2-heptanone, 2-octanone, 2-hexanone, 2-nonanone, 2-ethyl-furan, 2-pentyl-furan, 2-butyl-furan, 2-propyl-furan, 2-ethyl-6-methyl-pyrazine, 1-octen-3-ol, 2-ethyl-1-hexanol, or any combinations thereof.

In one aspect, the treated soy protein product described in this disclosure may have hexanal in an amount less than 480 ppb, preferably less than 30 ppb; heptanal in an amount less than 25 ppb, preferably less than 1 ppb; 2-heptanone in an amount less than 6 ppb, preferably less than 0.5 ppb; 2-ethyl-furan in an amount less than 0.1 ppb, preferably less than 0.01 ppb; 2-pentyl-furan in an amount less than 480 ppb, preferably less than 25 ppb; benzaldehyde in an amount less than 160 ppb, preferably less than 5 ppb; 2-ethyl-6-methyl-pyrazine in an amount less than 5 ppb, preferably less than 0.5 ppb; 1-octen-3-ol in an amount less than 10 ppb, preferably less than 0.5 ppb; octanal in an amount less than 0.1 ppb, preferably less than 0.01 ppb; 2-octanone in an amount less than 1.5 ppb, preferably less than 0.5 ppb; 2-butyl-furan in an amount less than 5 ppb, preferably less than 0.5 ppb; 2-ethyl-1-hexanol in an amount less than 8 ppb, preferably less than 1 ppb; 2-methyl-pentanal in an amount less than 3 ppb, preferably less than 1 ppb; 2-nonanone in an amount less than 0.1 ppb, preferably less than 0.01 ppb; 2-propyl-furan in an amount less than 0.1 ppb, preferably less than 0.01 ppb; 4-ethyl-benzaldehyde in an amount less than 1 ppb, preferably less than 0.01 ppb; 2,4-nonadienal in an amount less than 25 ppb, preferably less than 3 ppb; 2,4-decandienal in an amount less than 6 ppb, preferably less than 0.5 ppb; tolualdehyde in an amount less than 0.1 ppb, preferably less than 0.01 ppb; or any combinations thereof.

Preferably, the treated soy protein product described in this disclosure may be free of 2-ethyl-furan, octanal, 2-propyl-furan, tolualdehyde, or any combinations thereof.

Preferably, the treated soy protein product described in this disclosure has a reduced metal ion content as compared to an unwashed extruded soy protein material. In other words, the content of one or more metal ions in the treated soy protein product described in this disclosure is lower compared to an unwashed extruded soy protein material. Examples of metal ions may include, but may not be limited to, calcium ion, copper ion, iron ion, potassium ion, magnesium ion, sodium ion, or any combinations thereof.

Preferably, the treated soy protein product described in this disclosure may have one or more metal ions content that is at least 40%, preferably at least 50%, more preferably at least 60%, lower than the one or more metal ions content of an unwashed extruded soy protein material. The one or more metal ions may include, but may not be limited to, potassium ion, magnesium ion, sodium ion, or any combinations thereof.

In one aspect, the treated soy protein product may have a calcium ion content that is at least 3%, preferably at least 5%, more preferably at least 8% lower than the calcium ion content of an unwashed extruded soy protein material. The treated soy protein product may have a copper ion content that is at least 5%, preferably at least 7%, more preferably at least 9% lower than the copper ion content of an unwashed extruded soy protein material. In one aspect, the treated soy protein product may have an iron ion content that is at least 5%, preferably at least 8%, more preferably at least 10% lower than the iron ion content of an unwashed extruded soy protein material. The treated soy protein product may have a potassium ion content that is at least 65%, preferably at least 67%, more preferably at least 70% lower than the potassium ion content of an unwashed extruded soy protein material. The treated soy protein product may have a magnesium ion content that is at least 40%, preferably at least 42%, more preferably at least 45% lower than the magnesium ion content of an unwashed extruded soy protein material. The treated soy protein product may have a sodium ion content that is at least 55%, preferably at least 57%, more preferably at least 60% lower than the sodium ion content of an unwashed extruded soy protein material.

In one aspect, the treated soy protein product may have a phosphorus content that is at least 35%, preferably at least 38%, more preferably at least 40% lower than the phosphorus content of an unwashed extruded soy protein material.

Preferably, the treated soy protein product described in this disclosure has a reduced odor content as compared to an unwashed extruded soy protein material.

Preferably, the treated soy protein product described in this disclosure has a reduced carbohydrate content, preferably a reduced soluble carbohydrate content, as compared to an unwashed extruded soy protein material. In other words, the content of one or more carbohydrates in the treated soy protein product described in this disclosure is lower compared to an unwashed extruded soy protein material. Examples of carbohydrate may include, but may not be limited to, sucrose, raffinose, stachyose, or any combinations thereof.

Preferably, the treated soy protein product described in this disclosure may have one or more carbohydrates content that is at least 80%, preferably at least 85%, more preferably at least 90%, lower than the one or more carbohydrates content of an unwashed extruded soy protein material. The one or more metal ions may include, but may not be limited to, sucrose, raffinose, stachyose, or any combinations thereof.

In one aspect, the treated soy protein product may have a sucrose content that is at least 82%, preferably at least 85%, more preferably at least 88% lower than the sucrose content of an unwashed extruded soy protein material. The treated soy protein product may have a raffinose content that is at least 86%, preferably at least 91%, more preferably at least 95% lower than the raffinose content of an unwashed extruded soy protein material. The treated soy protein product may have a stachyose content that is at least 76%, preferably at least 81%, more preferably at least 85% lower than the stachyose content of an unwashed extruded soy protein material.

In one aspect, the treated soy protein product described in this disclosure may have sucrose in an amount less than 900 ppm, preferably less than 500 ppm; raffinose in an amount less than 200 ppm, preferably less than 50 ppm; and/or stachyose in an amount of less than 2500 ppm, preferably less than 1700 ppm.

Preferably, the treated soy protein product described in this disclosure has a reduced free amino acid content as compared to an unwashed extruded soy protein material. In other words, the content of one or more free amino acids in the treated soy protein product described in this disclosure is lower compared to an unwashed extruded soy protein material. Examples of free amino acids may include, but may not be limited to, histidine, serine, arginine, glycine, glutamic acid, threonine, alanine, tyrosine, methionine, valine, tryptophan, phenylalanine, isoleucine, leucine, lysine, or any combinations thereof.

Preferably, the treated soy protein product described in this disclosure may have one or more free amino acids content that is at least 80%, preferably at least 85%, more preferably at least 90%, lower than the one or more free amino acids content of an unwashed extruded soy protein material. The one or more free amino acids may include, but may not be limited to, aspartic acid, glutamic acid, alanine, valine, or any combinations thereof.

In one aspect, the treated soy protein product may have a histidine content that is at least 67%, preferably at least 70%, more preferably at least 73% lower than the histidine content of an unwashed extruded soy protein material. The treated soy protein product may have a serine content that is at least 74%, preferably at least 76%, more preferably at least 78% lower than the serine content of an unwashed extruded soy protein material. The treated soy protein product may have an arginine content that is at least 76%, preferably at least 79%, more preferably at least 82% lower than the arginine content of an unwashed extruded soy protein material. The treated soy protein product may have an aspartic acid content that is at least 85%, preferably at least 87%, more preferably at least 89% lower than the aspartic acid content of an unwashed extruded soy protein material. The treated soy protein product may have a glycine content that is at least 73%, preferably at least 74%, more preferably at least 75% lower than the glycine content of an unwashed extruded soy protein material. The treated soy protein product may have a glutamic acid content that is at least 83%, preferably at least 85%, more preferably at least 86% lower than the glutamic acid content of an unwashed extruded soy protein material. The treated soy protein product may have a threonine content that is at least 39%, preferably at least 44%, more preferably at least 50% lower than the threonine content of an unwashed extruded soy protein material. The treated soy protein product may have an alanine content that is at least 82%, preferably at least 89%, more preferably at least 97% lower than the alanine content of an unwashed extruded soy protein material. The treated soy protein product may have a tyrosine content that is at least 23%, preferably at least 30%, more preferably at least 38% lower than the tyrosine content of an unwashed extruded soy protein material. The treated soy protein product may have a methionine content that is at least 34%, preferably at least 35%, more preferably at least 36% lower than the methionine content of an unwashed extruded soy protein material. The treated soy protein product may have a valine content that is at least 97%, preferably at least 98%, more preferably at least 99% lower than the valine content of an unwashed extruded soy protein material. The treated soy protein product may have a tryptophan content that is at least 48%, preferably at least 50%, more preferably at least 52% lower than the tryptophan content of an unwashed extruded soy protein material. The treated soy protein product may have a phenylalanine content that is at least 57%, preferably at least 58%, more preferably at least 59% lower than the phenylalanine content of an unwashed extruded soy protein material. The treated soy protein product may have an isoleucine content that is at least 34%, preferably at least 42%, more preferably at least 50% lower than the isoleucine content of an unwashed extruded soy protein material. The treated soy protein product may have a leucine content that is at least 48%, preferably at least 52%, more preferably at least 55% lower than the leucine content of an unwashed extruded soy protein material. The treated soy protein product may have a lysine content that is at least 72%, preferably at least 75%, more preferably at least 78% lower than the glycine content of an unwashed extruded soy protein material.

In one aspect, the treated soy protein product described in this disclosure may have histidine in an amount less than 20 ppm, preferably less than 15 ppm; serine in an amount less than 8 ppm, preferably less than 6.5 ppm; arginine in an amount less than 280 ppm, preferably less than 200 ppm; aspartic acid in an amount less than 28 ppm, preferably less than 20 ppm; glycine in an amount less than 7 ppm, preferably less than 5.5 ppm; glutamic acid in an amount less than 15 ppm, preferably less than 12 ppm; threonine in an amount less than 6 ppm, preferably less than 4 ppm; alanine in an amount less than 6 ppm, preferably less than 2 ppm; tyrosine in an amount less than 28 ppm, preferably less than 23 ppm; methionine in an amount less than 7 ppm, preferably less than 5 ppm; valine in an amount less than 1 ppm, preferably less than 0.1 ppm; tryptophan in an amount less than 12 ppm, preferably less than 10 ppm; phenylalanine in an amount less than 8 ppm, preferably less than 6.5 ppm; isoleucine in an amount less than 4 ppm, preferably less than 3.5 ppm; leucine in an amount less than 4 ppm, preferably less than 3.5 ppm; lysine in an amount less than 18 ppm, preferably less than 14 ppm; total amino acids in an amount of less than 405 ppm, preferably less than 356 ppm, more preferably less than 312 ppm; or any combinations thereof.

In another aspect, the present invention also relates to a soy protein product that has one or more attributes as described below. Preferably, the treated soy protein product is made or washed by any method of the present invention as described in this disclosure.

Preferably, the soy protein product may have hexanal in an amount less than 480 ppb, preferably less than 30 ppb; heptanal in an amount less than 25 ppb, preferably less than 1 ppb; 2-heptanone in an amount less than 6 ppb, preferably less than 0.5 ppb; 2-ethyl-furan in an amount less than 0.1 ppb, preferably less than 0.01 ppb; 2-pentyl-furan in an amount less than 480 ppb, preferably less than 25 ppb; benzaldehyde in an amount less than 160 ppb, preferably less than 5 ppb; 2-ethyl-6-methyl-pyrazine in an amount less than 5 ppb, preferably less than 0.5 ppb; 1-octen-3-ol in an amount less than 10 ppb, preferably less than 0.5 ppb; octanal in an amount less than 0.1 ppb, preferably less than 0.01 ppb; 2-octanone in an amount less than 1.5 ppb, preferably less than 0.5 ppb; 2-butyl-furan in an amount less than 5 ppb, preferably less than 0.5 ppb; 2-ethyl-1-hexanol in an amount less than 8 ppb, preferably less than 1 ppb; 2-methyl-pentanal in an amount less than 3 ppb, preferably less than 1 ppb; 2-nonanone in an amount less than 0.1 ppb, preferably less than 0.01 ppb; 2-propyl-furan in an amount less than 0.1 ppb, preferably less than 0.01 ppb; 4-ethyl-benzaldehyde in an amount less than 1 ppb, preferably less than 0.01 ppb; 2,4-nonadienal in an amount less than 25 ppb, preferably less than 3 ppb; 2,4-decandienal in an amount less than 6 ppb, preferably less than 0.5 ppb; tolualdehyde in an amount less than 0.1 ppb, preferably less than 0.01 ppb; or any combinations thereof.

Preferably, the soy protein product may have sucrose in an amount less than 900 ppm, preferably less than 500 ppm; raffinose in an amount less than 200 ppm, preferably less than 50 ppm; and/or stachyose in an amount of less than 2500 ppm, preferably less than 1700 ppm.

Preferably, the soy protein product may have histidine in an amount less than 20 ppm, preferably less than 15 ppm; serine in an amount less than 8 ppm, preferably less than 6.5 ppm; arginine in an amount less than 280 ppm, preferably less than 200 ppm; aspartic acid in an amount less than 28 ppm, preferably less than 20 ppm; glycine in an amount less than 7 ppm, preferably less than 5.5 ppm; glutamic acid in an amount less than 15 ppm, preferably less than 12 ppm; threonine in an amount less than 6 ppm, preferably less than 4 ppm; alanine in an amount less than 6 ppm, preferably less than 2 ppm; tyrosine in an amount less than 28 ppm, preferably less than 23 ppm; methionine in an amount less than 7 ppm, preferably less than 5 ppm; valine in an amount less than 1 ppm, preferably less than 0.1 ppm; tryptophan in an amount less than 12 ppm, preferably less than 10 ppm; phenylalanine in an amount less than 8 ppm, preferably less than 6.5 ppm; isoleucine in an amount less than 4 ppm, preferably less than 3.5 ppm; leucine in an amount less than 4 ppm, preferably less than 3.5 ppm; lysine in an amount less than 18 ppm, preferably less than 14 ppm; total amino acids in an amount of less than 405 ppm, preferably less than 356 ppm, more preferably less than 312 ppm; or any combinations thereof.

In another aspect, the present invention also relates to a treated soy protein product that has one or more attributes as described below. Preferably, the washed treated soy protein product is subjected to the washing process of the present invention as described in this disclosure.

Preferably, the treated soy protein product may have hexanal in an amount less than 480 ppb, preferably less than 30 ppb; heptanal in an amount less than 25 ppb, preferably less than 1 ppb; 2-heptanone in an amount less than 6 ppb, preferably less than 0.5 ppb; 2-ethyl-furan in an amount less than 0.1 ppb, preferably less than 0.01 ppb; 2-pentyl-furan in an amount less than 480 ppb, preferably less than 25 ppb; benzaldehyde in an amount less than 160 ppb, preferably less than 5 ppb; 2-ethyl-6-methyl-pyrazine in an amount less than 5 ppb, preferably less than 0.5 ppb; 1-octen-3-ol in an amount less than 10 ppb, preferably less than 0.5 ppb; octanal in an amount less than 0.1 ppb, preferably less than 0.01 ppb; 2-octanone in an amount less than 1.5 ppb, preferably less than 0.5 ppb; 2-butyl-furan in an amount less than 5 ppb, preferably less than 0.5 ppb; 2-ethyl-1-hexanol in an amount less than 8 ppb, preferably less than 1 ppb; 2-methyl-pentanal in an amount less than 3 ppb, preferably less than 1 ppb; 2-nonanone in an amount less than 0.1 ppb, preferably less than 0.01 ppb; 2-propyl-furan in an amount less than 0.1 ppb, preferably less than 0.01 ppb; 4-ethyl-benzaldehyde in an amount less than 1 ppb, preferably less than 0.01 ppb; 2,4-nonadienal in an amount less than 25 ppb, preferably less than 3 ppb; 2,4-decandienal in an amount less than 6 ppb, preferably less than 0.5 ppb; tolualdehyde in an amount less than 0.1 ppb, preferably less than 0.01 ppb; or any combinations thereof.

Preferably, the treated soy protein product may have sucrose in an amount less than 900 ppm, preferably less than 500 ppm; raffinose in an amount less than 200 ppm, preferably less than 50 ppm; and/or stachyose in an amount of less than 2500 ppm, preferably less than 1700 ppm.

Preferably, the treated soy protein product may have histidine in an amount less than 20 ppm, preferably less than 15 ppm; serine in an amount less than 8 ppm, preferably less than 6.5 ppm; arginine in an amount less than 280 ppm, preferably less than 200 ppm; aspartic acid in an amount less than 28 ppm, preferably less than 20 ppm; glycine in an amount less than 7 ppm, preferably less than 5.5 ppm; glutamic acid in an amount less than 15 ppm, preferably less than 12 ppm; threonine in an amount less than 6 ppm, preferably less than 4 ppm; alanine in an amount less than 6 ppm, preferably less than 2 ppm; tyrosine in an amount less than 28 ppm, preferably less than 23 ppm; methionine in an amount less than 7 ppm, preferably less than 5 ppm; valine in an amount less than 1 ppm, preferably less than 0.1 ppm; tryptophan in an amount less than 12 ppm, preferably less than 10 ppm; phenylalanine in an amount less than 8 ppm, preferably less than 6.5 ppm; isoleucine in an amount less than 4 ppm, preferably less than 3.5 ppm; leucine in an amount less than 4 ppm, preferably less than 3.5 ppm; lysine in an amount less than 18 ppm, preferably less than 14 ppm; total amino acids in an amount of less than 405 ppm, preferably less than 356 ppm, more preferably less than 312 ppm; or any combinations thereof.

In one aspect, the attributes, other than the ones described above, of the treated soy protein product produced or treated (e.g., washed) by any method described in this disclosure can be improved as compared to the extruded soy protein material. Such attributes may include, but may not be limited to, taste, color, or any combinations thereof.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1

### Materials and Method

Three lots of extruded soy protein concentrate (TSC) (Cargill Incorporated) were obtained. Each lot was divided into washed and unwashed portions.

The unwashed portion was placed in a mylar bag and frozen.

The first wash began when 100 g TSC was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C. and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The washed sample had a final moisture content between 2.5 and 7%.

### Protein Content Evaluation

Moisture was measured by oven drying. Protein was analyzed using an Elementar combustion analyzer using a 6.25 conversion factor for all samples.

TSC raw materials had an average protein content of 74.3 wt %. After washing, the protein content of the washed samples was 80.5 wt. %. Thus, the washing process significantly increased protein content in the treated soy protein product.

### Example 2

### Materials and Method

Two lots of extruded soy protein concentrate (TSC) (Cargill Incorporated) were obtained. Each lot was divided into washed and unwashed portions.

The unwashed portion was placed in a mylar bag and frozen.

The first wash began when 100 g TSC was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C. and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The resulting washed sample had a final moisture content between 2.5 and 7%.

### Sensory Evaluation

An approach was developed to evaluate attributes of the overall intensity of a product. First, a standardized scale of a given product (e.g., textured soy protein concentrate) was prepared by creating a series of the products with varying intensities via concentration adjustment. Then, the intensity of the washed versions of that given product at a pre-set concentration were compared relative to the standardized scale. This approach provides an objective measure of a change in the aroma and flavor intensity compared to the same reference ingredient.

A composite sample, made with the two lots of unwashed TSC (raw material) comprising equal parts of each lot, was used to create an intensity reference curve. Samples for the reference curve were prepared by suspending the composite sample in de-ionized water and stirring the mixture for about 10 minutes at room temperature. The mixture was centrifuged and the supernatant was pulled through a Thermo Scientific Nalgene Rapid Flow filter unit (0.2-micron, aPES membrane, ~660 mmHg vacuum). Solutions were prepared at 0.1, 0.5, 1.0, 2.0, 3.0, and 5.0%. These composite samples were assigned random 3-digit codes and tasted independently by a trained panel (6 panelists) who were asked to place the reference standards in rank order of least to most intense and assign them to an unlabeled line scale. The leftmost (least intense) end of the line scale was water (0%) and the rightmost (most intense) end of the line scale was 5% solution, the rest of the samples were distributed in between. The panel leader then reviewed the data of the composite samples for panel agreement of sample intensity rank order and the software assigned numerical values (0-100). Panelists that were deemed outliers were removed and an average of the numerical values was taken for the remaining panelists. The average values became the scale values (0-100) for the reference standards and were anchored on the line accordingly for the remainder of the tests.

The panel blindly received the washed and unwashed samples at 3% concentration and assigned an intensity score to each sample using the reference scale they had created. Three samples of composite samples were also blindly presented to the panel.

Analysis of variance of the results as shown in Table 1 showed that the unwashed samples could not be distinguished from the unwashed composite samples. The overall model had a p<0.001 and an r² value of 0.98. The washed samples were statistically different from the unwashed samples using Tukey's method.

TABLE 1
Overall flavor intensity scores

| | Number of | Mean Intensity |
|---|---|---|
| Test Samples | Samples | Score |
| Composite (unwashed) | 3 | 87.1 |
| Unwashed | 3 | 78.1 |
| Washed | 3 | 20.6 |

A regression line could be fit between the intensity responses and the solutions concentrations (r²=0.97). Rearrangement of the equation allowed calculation of the apparent concentrations of the flavor compounds in the test samples. As shown in the Table 2, the washing process of the present invention decreased the flavor intensity by 92% compared to the unwashed samples.

TABLE 2
Intensity scores and apparent concentration

| | Mean | Apparent | % Decrease |
|---|---|---|---|
| | Intensity | Concentration | in Apparent |
| Test Samples | Score | (%) | Concentration |
| Composite (unwashed) | 87.1 | 3.7 | 0 |
| Unwashed | 78.1 | 2.5 | 32 |
| Washed | 20.6 | 0.2 | 92 |

### Example 3

### Materials and Method

Two lots of extruded soy protein concentrate (TSC) (Cargill Incorporated) were obtained. Each lot was divided into washed and unwashed portions.

The unwashed portion was placed in a mylar bag and frozen.

The first wash began when 100 g TSC was mixed with 500 g of water (pre-heated at 65° C.) that contained about 2.5 g of 25 wt % HCl. The resulting suspension was gently mixed to promote hydration and the pH was adjusted to 5.0 (+0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C. and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The resulting washed sample had a final moisture content between 2.5 and 7%.

### Untargeted GC/MS Analysis

Untargeted GC/MS analysis looks at the comprehensive overview of volatile compounds in different plant proteins. This approach is based on the fingerprinting of volatiles on gas chromatography (GC) and hi-resolution mass spectrometric (MS) identification. The overall purpose is to look at the volatile composition of the various samples and compare the different experimental treatments to look for differences and patterns.

Though untargeted GC/MS does not provide exact quantitative data, it does provide relative comparative potential. Every compound identified has an associated area count, which is the mass abundance of the fragment ions from the compounds, which can be a relative proxy for concentration. Since different compounds have different sensitivities, one compound cannot be compared to another, but one compound can be compared to itself provided a similar mass fragmentation process was conducted across the samples. Even in this case, the responsiveness may not be perfectly linear, but it is approximately linear.

Samples were subjected to untargeted GC/MS to look at the flavor component profiles of the various samples and compare the different experimental treatments to look for differences and patterns. A differential analysis was conducted by volcano plot to identify those peaks in the chromatogram that increased or decreased 2-fold and showed a significant difference (p<0.05) between washed and unwashed mean peak areas. About 680 peaks were observed and a bit more than half were neither increased/decreased more than 2-fold and had average peak areas that were significantly different between the washed and unwashed samples. Over 6-times as many peaks were decreased in area than increased in area.

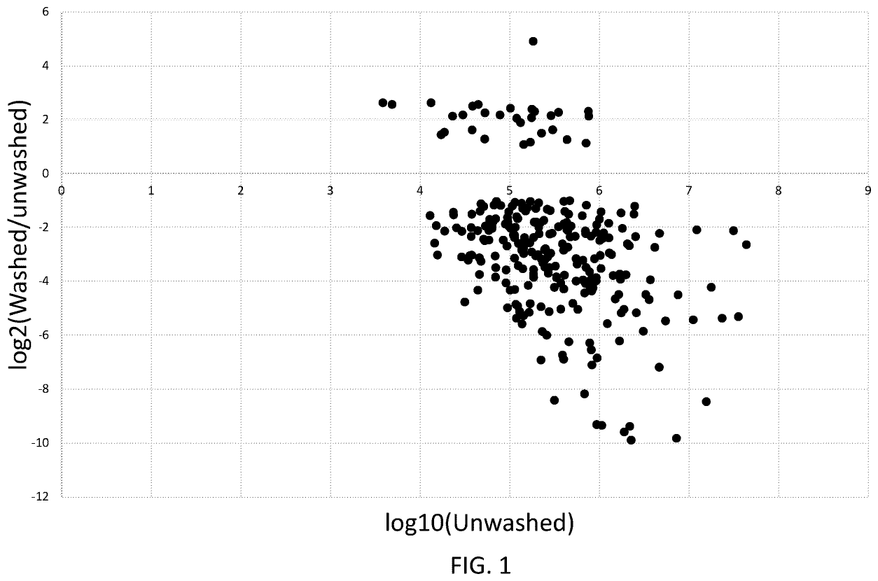

Typically, peaks that were initially small in area increased, while more prominent peaks tended to decrease. This is illustrated in the FIG. 1.

As observed in FIG. 1, a plot of the log base-2 ratio of washed-to-unwashed samples versus the log base-10 concentration of each compound in the unwashed sample, many more compounds were decreased than increased in concentration in the washed samples. It shows that the washing process distinctly changed the compound composition; importantly, the compounds being decreased in concentration are initially high in concentration, while those being increased are relatively low in concentration.

### Example 4

### Materials and Method

Two lots of extruded soy protein concentrate (TSC) (Cargill Incorporated) were obtained. Each lot was divided into washed and unwashed portions.

The unwashed portion was placed in a mylar bag and frozen.

The first wash began when 100 g TSC was mixed with 500 g of water (pre-heated at 65° C.) that contained about 2.5 g of 25 wt % HCl. The resulting suspension was gently mixed to promote hydration and the pH was adjusted to 5.0 (+0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C. and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The resulting soy washed sample had a final moisture content between 2.5 and 7%.

### Volatile Compounds Analysis

Volatile compounds (e.g., flavor components/compounds) in plant protein samples can be accurately quantitated by the targeted Gas Chromatography Flame Ionization Detector (GC/FID) analysis. Standards of volatiles of high concentration identified via the untargeted GC/MS analyses were purchased and a method was developed to best separate these volatile compounds from other compounds discovered in plant protein samples chromatographically. GC/FID relies on high resolution separation to ensure baseline resolution of each compound for accurate detection and quantitation. The operation of the FID is based on the detection of ions formed during combustion of volatile organic compounds in a hydrogen flame. The generation of these ions is proportional to the concentration of volatile organic species in the sample gas stream.

Volatile compounds from samples of treated soy protein product are extracted using solid-phase microextraction (SPME). Samples are weighed (0.25 g, the exact mass recorded to the nearest 0.0001 g) directly into a 20 mL headspace screw top vial (Thermo Chromacol 20-HSV). A small magnetic stir bar (VWR J201401) is added to the vial. To the vial, 5 mL of ultrapure water is added, and the vial is capped by a headspace-compatible cap (Gerstel 093640-040-00). The vial is rotated at 30 rpm for 20 minutes to fully mix and release volatiles from the sample matrix into the bulk liquid and headspace. Finally, the vial is loaded into the robotic autosampler for processing during the instrumental run. Replicates of each sample are prepared to remove variability and accurately quantitate the volatile compound levels.

A Gerstel robotic Pro autosampler is installed on the GC instrument. The SPME Fiber installed is a 1.10 mm Divinylbenzene/C-WR/PDMS SPME Arrow (Restek, P/N 27875). The SPME fiber is conditioned in the fiber conditioning unit set at 250° C. for 5 minutes before each sample sequence. In addition, the fiber is re-conditioned to minimize sample carryover by 250° C. for 5 minutes after each injection. For each injection, the SPME needle assembly is pushed through the septum on the vial containing the sample and the SPME fiber is exposed to the headspace; vial penetration is 54 mm and extracted for 90 minutes at 50° C. with stirring (250 rpm). The volatile compounds that are concentrated on the SPME-Arrow fiber are thermally desorbed in the GC inlet for the 90 seconds.

An Agilent 7890 GC is used for separation in this method. A mid-polar column (Restek RTX-624 60 m×250 μm, 1.4 μm film thickness (p/n: 10969), at 1.0 mL/min hydrogen flow.) with a thick film of stationary phase is used to achieve maximum theoretical plates for separation. Hydrogen gas is used as the carrier gas at a low flow rate (1.0 mL/min) to maximize interactions with the stationary phase and increase resolution.

Data is collected and analyzed using Chromeleon™ software. Peaks are integrated automatically by the software and manually checked and/or modified. Peak areas are used to create a calibration curve for each of the ten compounds used to calibrate the method (some compounds use surrogate standards for calibration). Peak areas of each volatile compound are compared to a calibration curve to quantitate the concentration in the sample (multiplied by the dilution factor of the sample preparation that is ~20×).

Table 3 lists the approximate concentrations of the identified volatile compounds present in the treated soy protein product. All concentrations are present in parts per billion (ppb) on a dry basis.

TABLE 3
Concentrations of volatile compounds
in treated soy protein product.

| | |
|---|---|
| Volatile | Concentration (ppb) |

| compound | Lower Limit | Upper Limit |
|---|---|---|
| Hexanal | 22.8 | 469.8 |
| Heptanal | 0.5 | 19.6 |
| 2-Heptanone | 0.3 | 5.5 |
| 2-Ethyl-furan | 0.0 | 0.0 |
| 2-Pentyl-furan | 23.6 | 459.0 |
| Benzaldehyde | 4.1 | 149.2 |
| 2-Ethyl-6- | 0.2 | 3.0 |
| methyl-pyrazine | | |
| 1-Octen-3-ol | 0.4 | 9.1 |
| Octanal | 0.0 | 0.0 |
| 2-Octanone | 0.2 | 1.0 |
| 2-Butyl-furan | 0.3 | 3.0 |
| 2-Ethyl-1- | 0.4 | 6.1 |
| hexanol | | |
| 2-Methyl- | 0.4 | 2.1 |
| pentanal | | |
| 2-Nonanone | 0.0 | 1.0 |
| 2-Propyl-furan | 0.0 | 0.0 |
| 4-Ethyl- | 0.0 | 1.0 |
| benzaldehyde | | |
| 2,4-Nonadienal | 2.6 | 19.4 |
| 2,4-Decandienal | 0.2 | 5.0 |
| Tolualdehyde | 0.0 | 0.0 |

As observed in Table 4, the washing process of the present invention significantly reduced concentration of many volatile compounds in the treated soy protein product. Four volatile compounds were shown to be almost completely eliminated from the treated soy protein product, while fifteen volatile compounds were shown to be removed from the treated soy protein product by at least 500%.

TABLE 4
Reduction of volatile compounds in treated soy protein products.

| | Decrease in Concentration (%) | | |
|---|---|---|---|
| Volatile compound | Mean | Lower Limit | Upper Limit |
| Hexanal | 12 | −1 | 25 |
| Heptanal | 72 | 69 | 75 |
| 2-Heptanone | 96 | 95 | 97 |
| 2-Ethyl-furan | 100 | 100 | 100 |
| 2-Pentyl-furan | 74 | 71 | 78 |
| Benzaldehyde | 81 | 80 | 83 |
| 2-Ethyl-6-methyl-pyrazine | 46 | 45 | 46 |
| 1-Octen-3-ol | 88 | 86 | 90 |
| Octanal | 100 | 100 | 100 |
| 2-Octanone | 98 | 93 | 102 |
| 2-Butyl-furan | 90 | 87 | 93 |
| 2-Ethyl-1-hexanol | 56 | 40 | 71 |
| 2-Hexanone | 100 | 100 | 100 |
| 2-Nonanone | 94 | 93 | 95 |
| 2-Propyl-furan | 100 | 100 | 100 |
| 4-Ethyl-benzaldehyde | 64 | 59 | 70 |
| 2,4-Decandienal | 43 | 21 | 64 |
| Tolualdehyde | 100 | 100 | 100 |

### Example 5

### Materials and Method

Three lots of extruded soy protein concentrate (TSC) (Cargill Incorporated) were obtained.

The first wash began when TSC was mixed with water (pre-heated at 65° C.) at a mass ratio of, TSC to water, 1:10. The pH of the resulting suspension was adjusted to 5 and the suspension was then placed in a 65° C. water bath to maintain the temperature for 10 minutes. The water was removed by filtration through an aluminum screen for 5 minutes (with no drainage apparently visible after 3 minutes). After draining for 5 minutes, the washed solids were retrieved.

A second wash began when the washed solids were resuspended in fresh water (pre-heated at 65° C.) at a mass ratio of, washed solids to water, 1:7.5. The mixture was placed in a 65° C. water bath to maintain the temperature for 10 minutes. Water was drained out using the same screening method as in the first wash to retrieve the twice-washed solids.

A third wash began when the twice-washed solids were resuspended in fresh water (pre-heated at 65° C.) at a mass ratio of, washed solids to water, 1:7.5. The mixture was placed in a 65° C. water bath to maintain the temperature for 10 minutes. Water was drained out using the same screening method as in the first and second washes and the obtained thrice-washed solids (i.e., washed TSC) were dried at 115° C. overnight under vacuum.

Samples of the starting TSC materials (i.e., unwashed TSC) and the corresponding washed TSC were analyzed by inductively coupled plasma (ICP-MS). All values were corrected to a dry weight basis before statistical analysis.

### Results

As shown in Table 5, potassium ions showed a significant difference in mean concentrations between washed and unwashed textured soy protein samples; the decline in Na concentration was about 60%. After computation of the change, both potassium and sodium ions showed quite large effects of washing. Ions such as Ca, Cu, Fe, K, Mg, and Na were at lower concentrations after washing. Though the average concentration of Cu appears unchanged, there was a considerable difference in the Cu concentrations in the unwashed samples. Paired comparisons showed that washing decreased the Cu concentration slightly. Phosphorus content was also reduced after washing.

TABLE 5
Reduction in metal ions and phosphorus content
in treated soy protein products.

| | | |
|---|---|---|
| Ion Concentration | | |
| (ppm) | Average | Average |

| | Unwashed | Washed | change (ppm) | change % |
|---|---|---|---|---|
| Ca | 3,794 | 3,596 | −198 | −5% |
| Cu | 10 | 9 | −0.73 | −7% |
| Fe | 117 | 108 | −9.233 | −8% |
| K | 21,534 | 7,084 | −14,450 | −67% |
| Mg | 3,181 | 1,848 | −1,333.4 | −42% |
| Na | 110 | 47 | −62.3 | −57% |
| P | 8,863 | 5,481 | −3,382 | −38% |

### Example 6

### Materials and Method

Three lots of extruded soy protein concentrate (TSC) (Cargill Incorporated) were obtained. Each lot was divided into washed and unwashed portions.

The unwashed portion was placed in a mylar bag and frozen.

The first wash began when 100 g TSC was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C. and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The washed sample had a final moisture content between 2.5 and 7%.

### Odor Evaluation

Some aroma-active compounds (e.g., sulfur-containing compounds) have a very low sensory threshold and humans can detect them in products at very low levels (parts per trillion). These sorts of compounds exist in products at levels that instrumental detectors typically cannot detect. As such, the human nose is far more sensitive for these compounds and gas chromatography olfactometry (GC-0) utilizes the human nose as the primary detector.

A composite sample, made with equal portions of the two lots of TSC (raw material), was analyzed by GC-O. A washed sample, made from one of the lots in the composite sample, was also tested.

Samples for GC-O analysis were prepared by adding 10 ml ultrapure water to 0.5 g washed samples and 0.5 g unwashed composite samples in separate 20 ml GC headspace vials. Samples were mixed by rotation for 20 minutes at 30 rpm. Samples were incubated at 50° C. with stirring for 5 minutes and extracted with solid phase microextraction Arrow (SPME-Arrow) Divinylbenzene/Polydimethylsiloxane (DVB/PDMS) fiber for 30 minutes at 50° C. with stirring.

Two individuals with 6 and 13 years of GC-O experience smelled the GC column effluent and logged “odor events” by pressing a button to capture the GC runtime and a recording of their spoken description of the odor. Each panelist ran each sample in duplicate (i.e., 2 panelists×2 replicates=4 total GC-O runs for each sample). The total number of odor events for washed or unwashed samples were averaged.

As shown in Table 6, this GC-O analysis approach showed washing of TSC reduced the average total of odor events by 4% of the unwashed sample.

TABLE 6
GC-O analysis

| | Unwashed | Washed |
|---|---|---|
| Test Samples | Composite Sample | Sample |
| Average Number of | 24.3 | 23.3 |
| Odor Events | | |
| Odor Events Reduced (%) | — | 4 |

### Example 7

### Materials and Method

Three lots of extruded soy protein concentrate (TSC) (Cargill Incorporated) were obtained. Each lot was divided into washed and unwashed portions.

The unwashed portion was placed in a mylar bag and frozen.

The first wash began when 100 g TSC was mixed with 500 g of water (pre-heated at 65° C.) that contained about 2.5 g of 25 wt % HCl. The resulting suspension was gently mixed to promote hydration and the pH was adjusted to 5.0 (±0.1) with 25 wt % NaOH or 25 wt % HCl, as appropriate. The suspension was then placed in a 65° C. water bath to maintain the temperature for 10 minutes. The liquid and solids were separated using a 100-micron screen with a fitted weight to promote drainage. After draining for 5 minutes, the washed solids were retrieved.

A second wash began when the washed solids were resuspended in fresh 500 g of water (pre-heated at 65° C.) without pH adjustment. The mixture was placed in a 65° C. water bath to maintain the temperature for 10 minutes. Water was drained out using the same screening method as in the first wash to retrieve the twice-washed solids.

A third wash began when the twice-washed solids were resuspended in another fresh 500 g of water (pre-heated at 65° C.) without pH adjustment. The mixture was placed in a 65° C. water bath to maintain the temperature for 10 minutes. Water was drained out using the same screening method as in the first and second washes and the obtained thrice-washed solids were spread on an aluminum sheet. The thrice-washed solids were partially dried at 90° C. and 0% relative humidity (RH) in a Unox Cheftop combi-oven for 30 minutes with stirring at the 10^{th} minute and the 20^{th} minute. The partially dried solids were then brought to the final moisture level (between 2.5 and 7%) using a fluid bed dryer (Sherwood Tornado Model 501) with temperature set at 75° C. for 15 minutes to obtain the treated soy protein product (washed samples). Air flow was adjusted between a setting of 50 and 75 to ensure fluidization of the bed. The washed sample had a final moisture content between 2.5 and 7%.

### Carbohydrate Content Evaluation

Carbohydrate quantitation on the samples was performed by High Pressure Ion Chromatography (HPIC), separated by a CarboPac™ PA1 column using Pulsed Amperometric Detection (PAD).

As shown in Table 7, the washed and unwashed samples had different soluble carbohydrate profiles, with some sugars being rendered absent by the washing treatment.

Table 7 lists the approximate concentrations of the identified carbohydrates present in the treated soy protein product. All concentrations are present in parts per million (ppm) on a dry basis.

TABLE 7
Concentration of carbohydrates in treated soy protein products.

Concentration (ppm)

| Saccharide | Lower Limit | Upper Limit |
|---|---|---|
| Sucrose | 308 | 838 |
| Raffinose | 46 | 162 |
| Stachyose | 1661 | 2389 |

The effect of washing itself is revealed by the sample-by-sample mean change in concentration due to washing. As shown in Table 8, the washing process of the present invention significantly reduced concentration of many carbohydrates present in the treated soy protein product.

TABLE 8
Reduction of carbohydrates in treated soy protein products.

| | Decrease in concentration (%) | | |
|---|---|---|---|
| Saccharide | Mean | Lower Limit | Upper Limit |
| Sucrose | 85 | 82 | 88 |
| Raffinose | 91 | 86 | 95 |
| Stachyose | 81 | 76 | 85 |

### Free Amino Acid Evaluation

Free amino acid concentrations were analyzed before and after washing by UHTPLC/UV utilizing pre-column derivatization with diethyl ethoxymethylenemalonate (DEEMM) and separated by reversed phase C8 column.

Table 9 lists the approximate concentrations of the identified free amino acids present in the treated soy protein product. All concentrations are present in parts per million (ppm) on a dry basis. In general, the concentrations of free amino acids dropped significantly after washing.

TABLE 9
Concentration of free amino acids in treated soy protein products.

Concentration (ppm)

| Amino Acids | Mean | Lower Limit | Upper Limit |
|---|---|---|---|
| Histidine | 14.9 | 12.6 | 17.2 |
| Proline | 0.0 | 0.0 | 0.0 |
| Serine | 7.0 | 6.2 | 7.8 |
| Arginine | 232.0 | 193.2 | 270.8 |
| Aspartic acid | 22.9 | 18.5 | 27.3 |
| Glycine | 5.6 | 5.0 | 6.2 |
| Glutamic acid | 12.8 | 11.9 | 13.7 |
| Threonine | 4.0 | 3.9 | 4.1 |
| Alanine | 3.4 | 1.1 | 5.7 |
| Tyrosine | 24.3 | 22.9 | 25.7 |
| Methionine | 5.0 | 4.6 | 5.3 |
| Valine | 0.0 | 0.0 | 0.0 |
| Cystine | 0.0 | 0.0 | 0.0 |
| Tryptophan | 10.2 | 9.8 | 10.5 |
| Phenylalanine | 6.7 | 6.4 | 7.1 |
| Isoleucine | 3.4 | 3.0 | 3.7 |
| Leucine | 3.5 | 3.2 | 3.8 |
| Lysine | 14.6 | 12.9 | 16.3 |
| Total | 355.6 | 311 | 401 |

To account for potential variation in the starting material, pair differences are computed and analyzed. Results are shown in Table 10 in which the mean decrease (%) of the washed samples against the unwashed samples is expressed as the 95% confidence interval.

The change in concentration caused by washing process ranged from about 400% to 1000%. Thus, the washing process of the present invention significantly reduced concentration of many free amino acids in the treated soy protein product.

TABLE 10
Free amino acids mean change.

Decrease in Concentration (%)

| Amino Acids | Mean | Lower Limit | Upper Limit |
|---|---|---|---|
| Histidine | 70 | 67 | 73 |
| Serine | 76 | 74 | 78 |
| Arginine | 79 | 76 | 82 |
| Aspartic acid | 87 | 85 | 89 |
| Glycine | 74 | 73 | 75 |
| Glutamic acid | 85 | 83 | 86 |
| Threonine | 44 | 39 | 50 |
| Alanine | 89 | 82 | 97 |
| Tyrosine | 30 | 23 | 38 |
| Methionine | 35 | 34 | 36 |
| Valine | 100 | 100 | 100 |
| Tryptophan | 50 | 48 | 52 |
| Phenylalanine | 57 | 57 | 58 |
| Isoleucine | 42 | 34 | 50 |
| Leucine | 52 | 48 | 55 |
| Lysine | 75 | 72 | 78 |
| Total | 78 | 75 | 80 |

1. A method of making a treated soy protein product, comprising the steps of:
a. providing an extruded soy protein material; and
b. performing a washing step on the extruded soy protein material to obtain the treated soy protein product, wherein the washing step comprises washing the extruded soy protein material at a washing temperature of from room temperature to 85° C. with a washing agent in a ratio of, washing agent to extruded soy protein material, from 4:1 to 40:1;
wherein the treated soy protein product has one or more improved attributes compared to the extruded soy protein material and the one or more improved attributes are selected from the group consisting of an increased protein content, a reduced flavor component content, a reduced metal ion content, a reduced odor content, a reduced carbohydrate content, a reduced free amino acid content, and any combinations thereof.

2. The method of any of claim 1, wherein the treated soy protein product has a protein content of at least 75 wt % on a dry basis.

3. (canceled)

4. The method of claim 1, further comprising a step of:
c. drying the treated soy protein product at a drying temperature of from 75° C. to 120° C.

5. The method of claim 1, wherein one or more process parameters of the method are the same or different in each washing step, and the one or more process parameters are selected from the group consisting of a ratio of the washing agent to the extruded soy protein material, pH of the washing agent, washing temperature, and duration of washing.

6. A method of washing an extruded soy protein material, comprising the steps of:
a. washing the extruded soy protein material at a washing temperature of from room temperature to 85° C. with a washing agent in a ratio of, washing agent to extruded soy protein material, from 4:1 to 40:1 to obtain a washed material; and
b. drying the washed material at a drying temperature of from 75° C. to 120° C. to obtain a treated soy protein product;
wherein the treated soy protein product has one or more improved attributes compared to the extruded soy protein material and the one or more improved attributes are selected from the group consisting of an increased protein content, a reduced flavor component content, a reduced metal ion content, a reduced odor content, a reduced carbohydrate content, a reduced free amino acid content, and any combinations thereof.

7. The method of claim 6, wherein the treated soy protein product has a protein content of at least 75 wt % on a dry basis.

8. (canceled)

9. The method of claim 6, wherein one or more process parameters of the method are the same or different in each washing step, and the one or more process parameters are selected from the group consisting of a ratio of the washing agent to the extruded soy protein material, pH of the washing agent, washing temperature, and duration of washing.

10. (canceled)

11. A treated soy protein product having one or more improved attributes compared to an unwashed extruded soy protein material, wherein the one or more improved attributes are selected from the group consisting of an increased protein content, a reduced flavor component content, a reduced metal ion content, a reduced odor content, a reduced carbohydrate content, a reduced free amino acid content, and any combinations thereof.

12. (canceled)

13. (canceled)

14. (canceled)

15. The treated soy protein product of claim 11, wherein the flavor component is selected from the group consisting of furan, pyran, organic acid, aldehyde, alcohol, ketone, pyrazine, lactone, thiol, sulfide, and any combinations thereof.

16. The treated soy protein product of claim 11, wherein the reduced flavor component content is selected from the group consisting of a lower hexanal content, a lower ketone content, a lower furan content, a lower pyrazine content, a lower alcohol content, compared to an unwashed extruded soy protein material.

17. (canceled)

18. (canceled)

19. (canceled)

20. (canceled)

21. The treated soy protein product of claim 11, wherein the flavor component is selected from the group consisting of hexanal, heptanal, benzaldehyde, octanal, 2-methyl-pentanal, 4-ethyl-benzaldehyde, 2,4-nonadienal, 2,4-decandienal, tolualdehyde, 2-heptanone, 2-octanone, 2-hexanone, 2-nonanone, 2-ethyl-furan, 2-pentyl-furan, 2-butyl-furan, 2-propyl-furan, 2-ethyl-6-methyl-pyrazine, 1-octen-3-ol, 2-ethyl-1-hexanol, and any combinations thereof.

22. The treated soy protein product of claim 11, having one or more flavor components content at least 50%, preferably at least 75%, more preferably at least 90%, lower than the one or more flavor components content of an unwashed extruded soy protein material, wherein the one or more flavor components are selected from the group consisting of heptanal, 2-heptanone, 2-ethyl-furan, 2-pentyl-furan, benzaldehyde, 1-octen-3-ol, octanal, 2-octanone, 2-butyl-furan, 2-ethyl-1-hexanol, 2-hexanone, 2-nonanone, 2-propyl-furan, 4-ethyl-benzaldehyde, tolualdehyde, and any combinations thereof.

23. The treated soy protein product of claim 11, wherein one or more flavor component content is at least 90%, preferably at least 95%, more preferably at least 99%, lower than the one or more flavor components content of an unwashed extruded soy protein material, wherein the one or more flavor components are selected from the group consisting of 2-ethyl-furan, octanal, 2-propyl-furan, tolualdehyde, and any combinations thereof.

24. (canceled)

25. The treated soy protein product of claim 11, wherein the metal ion is selected from the group consisting of calcium ion, copper ion, iron ion, potassium ion, magnesium ion, sodium ion, and any combinations thereof.

26. The treated soy protein product of claim 11, having one or more metal ions content at least 40%, preferably at least 50%, more preferably at least 60%, lower than the one or more metal ions content of an unwashed extruded soy protein material, wherein the one or more metal ions are selected from potassium ion, magnesium ion, sodium ion, and any combinations thereof.

27. (canceled)

28. (canceled)

29. (canceled)

30. The treated soy protein product of claim 11, which has a lower carbohydrate content, preferably a lower sucrose, raffinose, and stachyose and/or content, compared to an unwashed extruded soy protein material.

31. The treated soy protein product of claim 11, having one or more carbohydrates content at least 82%, preferably at least 85%, more preferably at least 88%, lower than the one or more carbohydrates content of an unwashed extruded soy protein material, wherein the one or more carbohydrates are selected from the group consisting of sucrose, raffinose, stachyose, and any combinations thereof.

32. (canceled)

33. The treated soy protein product of claim 11, having one or more free amino acids content at least 80%, preferably at least 85%, more preferably at least 90%, lower than the one or more free amino acids content of an unwashed extruded soy protein material, wherein the one or more free amino acids are selected from the group consisting of aspartic acid, glutamic acid, alanine, valine, and any combinations thereof.

34. The treated soy protein product of claim 11, which is washed by the method of any of claims 1 to 9.
